(19) United States
(12) Patent Application Publication
(10) Pub. No.: US 2025/0204648 A1
(43) Pub. Date: Jun. 26, 2025

(54) METHOD AND DEVICE FOR PRODUCING A FASTENER PART

(71) Applicant: Gottlieb Binder GmbH & Co. KG, Holzgerlingen (DE)

(72) Inventors: Lars Heepe, Tübingen (DE); Dirk-Michael Drotlef, Tiefenbronn (DE); Halvor Tramsen, Holzgerlingen (DE)

(73) Assignee: Gottlieb Binder GmbH & Co. KG, Holzgerlingen (DE)

(21) Appl. No.: 18/991,157

(22) Filed: Dec. 20, 2024

(30) Foreign Application Priority Data
Dec. 22, 2023 (DE) 10 2023 213 266.4
Jun. 17, 2024 (DE) 10 2024 205 551.4

(51) Int. Cl. A44B 18/00; B29C 43/22; B29L 31/00

(52) U.S. Cl. CPC A44B 18/0049; B29C 43/222; B29L 2031/729

(57) ABSTRACT

A method for producing a touch-and-close fastener part has a plurality of adhesive elements with front-side contact surfaces for releasable adhesion to other components by an adhesive force. The adhesive elements are formed from a coating material in mold cavities of a mold screen of a molding tool. In the method, a carrier web is fed to the coating material and the adhesive elements are formed in the mold cavities of the molding tool on a side of the carrier web facing the coating material. The carrier web is preferably connected to the coating material before the adhesive elements are formed. A device for producing the touch-and-close fastener part is disclosed.

### CROSS REFERENCE TO RELATED APPLICATIONS

This application claims priority to German Patent Application Nos. DE 102023213266.4 filed Dec. 22, 2023 and DE 102024205551.4 filed Jun. 17, 2024, the entire contents of which are hereby incorporated in full by this reference.

### DESCRIPTION

### Field of the Invention

The invention relates to a method for producing a fastener part which has a plurality of adhesive elements with front-side contact surfaces for releasable adhesion to other components by means of adhesive force. The adhesive elements are formed in mold cavities of a mold screen of a molding tool from a coating material. The invention further relates to a device for producing a fastener part, comprising: a molding tool with a mold screen in which mold cavities are formed, and a feed device for feeding a coating material to the mold cavities of the molding tool, which are designed to form a plurality of adhesive elements with front-side contact surfaces for releasable adhesion to other components by means of adhesive force. The invention also relates to a fastener part, comprising: a plurality of adhesive elements made of a coating material with front-side contact surfaces for releasable adhesion to other components by means of adhesive force.

### Background of the Invention

WO 2012/031658 A1 describes a fastener part with a carrier part and fastener parts arranged on top of it, each of which has a head part that has at least one contact surface on its free end face for releasable adhesion to another component by means of adhesive force. During the manufacture of the fastener part, the fastener parts are formed in mold cavities of a metallic mold screen by pressing a coating material or plastic material into the mold cavities of the mold screen and forming the fastener parts from the coating material on a side of the carrier part associated with a mold roller.

As also described in WO 2012/031658 A1, the adhesion mechanism used for detachable adhesion to (at least) one other component is the so-called Van der Waals interaction, which is classically regarded as a subgroup of adhesion. Adhesion enables reliable adhesion of the adhesive elements even to components with smooth surfaces, for example window glass. Adhesion is made possible, among other things, by the fact that the contact surfaces have a comparatively small surface area of, for example, approx. 0.2 μm² to approx. 0.5 μm².

EP1827795B1 describes a method for producing a carrier web from a predeterminable amount of plastic material with a plurality of mold elements that are formed in mold cavities of a molding tool and that are designed as mushroom-shaped hooking means. In part of the mold cavities, a cavity is formed inside the mold element. The respective cavity in the mold element can be closed at least on one side by a closure web. The hooking means are intended to be brought into engagement with other hooking means, for example with fleece or hook material.

US 2024/0034912 A1 describes a microfiber array having a plurality of fibers with roughened tips that are brought into contact with a surface of a smooth, flat object. The microfiber array is intended to provide friction against movement in a horizontal direction and controllable adhesion for easy separation from the surface of the object in a vertical direction. The microfiber array is formed using a mold made of a curable polymer. A potting material can be used to form a negative cast of the microfiber array with the roughened tips, and further microfiber arrays can be formed using the negative cast.

In the article “Enhanced Flexible Mold Lifetime for Roll-to-Roll Scaled-Up Manufacturing of Adhesive Complex Microstructures”, J.-K. Kim et al., Adv. Mater. 2023, 35, 2207257, a roll-to-roll process for producing micro-/nanostructured surfaces, e.g., in the form of gecko-inspired microfiber adhesives, is described. It is proposed to increase the lifetime of a flexible microstructured silicone mold used in the roll-to-roll process by performing a two-stage curing process with UV light.

EP3448671B1 describes a method for assembling an arrangement comprising a strip of holding elements and a substrate. In a step of forming the strip, the strip of holding elements is formed by distributing a molding material in a molding device. Following the step of forming the strip, the substrate is applied to an underside of a base of the strip facing away from the holding elements before the underside of the base of the strip solidifies.

### SUMMARY OF THE INVENTION

### Task of the Invention

It is the object of the invention to provide a robustly implementable method and a corresponding device in which material can be saved during the production of the adhesive fastener part. It is also the object of the invention to provide a corresponding adhesive fastener part.

### Description of the Invention

This object is achieved according to a first aspect by a method of the type mentioned at the outset, in which a carrier web is fed to the coating material and the adhesive elements are formed on a side of the carrier web facing the coating material in the mold cavities of the mold, wherein the carrier web is preferably connected to the coating material before the adhesive elements are formed. In the present application, the terms plastic material and coating material as well as the terms plastic web and coating web are used as synonyms.

In the method according to the invention, a carrier web is fed to the coating material, to which the coating material is connected when the adhesive elements are formed. This increases the robustness of the manufacturing process, as it becomes less sensitive to the rheology of the coating material. The carrier web connected to the coating material can also prevent the coating material from tearing during the manufacturing process, for example when demolding from the mold, or the coating material can be made thinner than would be the case in a manufacturing process without the use of the carrier web. The coating material can be drawn into the molding tool by capillary forces.

It is advantageous if the connection between the carrier web and the coating material is made before the adhesive elements are formed. The coating material can, for example, be connected to the carrier web in the manner of a coating. The connection can, for example, be achieved by feeding the (strip-shaped) coating material and the carrier web together to the shaping tool and resting against one another during or before feeding to the shaping tool. It is also possible for the coating material and the carrier web to be pressed against one another during feeding in order to facilitate the connection of the carrier web to the coating material. The connection between the coating material and the carrier web is thus made before the carrier web and the coating material reach the shaping tool.

In one variant, when forming the adhesive elements between the carrier web and the adhesive elements from the coating material, a coating web is formed which has a thickness of 2 mm or less, preferably 300 μm or less, particularly preferably 200 μm or less, very particularly preferably 50 μm or less, extremely preferably 30 μm or less, in particular, 10 μm or less. In this variant, the adhesive elements are formed on the side of the one-piece coating web facing away from the carrier web by the coating material being pressed into the mold cavities of the mold or flowing into them. Due to the carrier web to which it is connected, the thickness of the coating web can be significantly lower than when producing the adhesive fastener part without using the carrier web. In this way, coating material can be saved when producing the adhesive fastener part and energy can be saved when polymerizing the coating material, i.e., a more sustainable adhesive fastener part can be produced with the same functionality. Due to the lower thickness of the coating layer, the flexibility of the adhesive fastener part is increased, which can have a positive effect on the adhesion properties of the adhesive fastener part, e.g., on components with curved surfaces.

In a further variant, after the adhesive elements have been removed from the mold cavities of the mold, the carrier web is separated from the coating web. In this case, the carrier web is a sacrificial web that is only used to make the manufacturing process more robust but is no longer used on the fastener part itself. It is also possible for the carrier web to have an adhesive layer or an adhesive coating on the side facing the coating material, which remains on the coating web with the adhesive elements after the carrier web has been separated from the coating web. In this case, the separation of the carrier web from the coating web is typically carried out by an operator immediately before the fastener part is used, e.g., to attach it to a rigid component with the adhesive layer.

Alternatively, the carrier web can be permanently or inseparably bonded to the coating web and form part of the adhesive fastener part. The permanent connection between the carrier web and the coating web can be made, in particular, without the use of a joining agent in the form of an adhesive. If necessary, the carrier web can have an adhesion promoter layer or be subjected to a surface treatment to create the permanent connection (see below).

In an alternative variant, the adhesive elements are formed directly on the side of the carrier web facing the coating material. In this case, there is no continuous coating web, but rather the adhesive elements are formed directly—individually—on the carrier web. In this way, a particularly thin and particularly flexible adhesive fastener part can be produced.

It is possible that the side of the carrier web facing the coating material is surface-treated or provided with an adhesion promoter to improve adhesion when bonding with the coating material. Depending on the type of coating material, e.g., if it is a polysiloxane, this may be difficult to bond to other materials. It may therefore be advantageous to subject the carrier web to a surface treatment to improve adhesion, for example a plasma treatment or gas phase fluorination. An adhesion promoter or crafting, for example using end-group functionalized silanes, or the use of an adhesion promoter layer is also possible.

In a further variant, the coating material is cured after the adhesive elements have been formed by heat, e.g., by thermal radiation, by light, preferably by UV light, and/or by atmospheric humidity. The coating material is usually a molding compound, in particular, a cross-linkable molding compound. Depending on the type of coating material used, it is necessary to cure it by cross-linking molecules or molecular chains. Curing can be carried out or promoted, for example, by heating the molding tool, which is designed as a molding roller, for example. However, it is also possible to bring about curing by heat, by light, e.g., by UV light, and/or by the humidity of the ambient air, usually after the adhesive fastener part has been demolded from the molding tool. It is also possible for the coating material to be suitably prepared for curing, for example by containing a catalyst, e.g., platinum, in the coating material or mixing it with it. This is the case, for example, with a coating material in the form of 2-component silicone rubber, which vulcanizes and hardens due to the catalyst.

In a further variant, the carrier web has a thickness of 10 mm or less, preferably 60 μm or less, particularly preferably 40 μm or less. In order to save material during production and to prevent the adhesive fastener part from being too rigid, the carrier web should typically have a small thickness. However, the thickness of the carrier web should not be chosen to be too small and should generally be around 25 μm or more. A comparatively thin carrier web is flexible and makes it easier to form the adhesive elements in the mold cavities of the mold, for example if the mold has a band-shaped mold screen (see below).

In a further variant, the carrier web is designed as a flexible component, preferably as a film, in particular, as an information-bearing film, or as a rigid component. The carrier web can be a flexible, pliable and preferably inelastic component or a rigid component. The carrier web can, in particular, be a film that is elastic, plastic or inelastic. The carrier web in the form of the film can be made, for example, from polyurethane (PUR), from polyethylene terephthalate (PET) or from acrylate foam. In particular, it can be an information-bearing film as described in DE102020004438A1, which is made part of the content of this application in its entirety by reference. The information-bearing film can, for example, be colored, printed with an imprint, e.g., with symbols, preferably with text, printed, e.g., for advertising purposes, reflective, fluorescent, luminous, matt or glossy, provided with sensors, e.g., as a flexible display, or provided with AI. The sensors can be embedded in the carrier web to protect it from the environment. It can also be a rigid carrier web or a rigid component onto which the holding elements are formed.

The carrier web can be smooth or structured on the side facing away from the coating material or the coating web. For example, the carrier web can have fastening elements which can be loop-shaped, for example, and interact with corresponding fastening elements which can be hook-shaped, for example, with another component in the manner of a Velcro fastener. The carrier web can also have two or more layers, between which a flexible material is introduced, for example in the form of fibers or the like, in order to enable adaptation to rough, curved or wavy surfaces.

In a further variant, a carrier web is fed to the coating material, which has a multiplicity of further adhesive elements made of a coating material with front-side contact surfaces for releasable adhesion to other components by means of adhesive force on a side facing away from the coating material. The multiplicity of further adhesive elements on the side facing away from the coating material can have been formed on the carrier web in the same way as the adhesive elements on the side of the carrier web facing the coating material. In this case, the carrier web passes through the device for producing the adhesive fastener part twice, with the sides of the carrier web being aligned in opposite directions during the two passes through the device.

In a further variant, the carrier web is selected from the group comprising: textile, nonwoven, mesh, foam, in particular, acrylate foam. The material of the carrier web is preferably selected from the group comprising: elastomers, thermoplastic elastomers, thermoplastics, thermosets, adhesives. The carrier web can be designed in various ways. The carrier web can also be made from sustainable raw materials, for example from paper, usually from coated paper. In particular, the carrier web can be made from a thermoplastic plastic, e.g., in the form of a film. This enables thermoforming of the carrier web or the adhesive fastener part, for example by means of a deep-drawing process. In this way, the adhesive elements can extend in different directions and adhere to one or more components in different directions. The material of the carrier web can be functionalized. For example, the material of the carrier web can have heat-conducting properties or a high thermal conductivity. To achieve good thermal conductivity, the carrier web can be designed, for example, as an HDPE film. If the carrier sheet is a foam, the functionalization can consist, for example, of an anti-flame retardant material. The carrier sheet in the form of a foam or a silicone material can have a considerable thickness, e.g., on the order of several millimeters, to enable adaptation to uneven surfaces. The carrier sheet can also improve the stress distribution of the adhesive fastener part or the rigidity of the adhesive fastener part can be adjusted. For example, depending on the material selected for the carrier sheet, the adhesive fastener part may no longer be stretchable. The carrier sheet does not necessarily have to be full-surface or designed as a continuous carrier sheet; it can instead have openings or holes and be designed, for example, in the manner of a net.

In a further variant, the plastic material or coating material is selected from the group comprising: elastomers, preferably polyurethanes, polysiloxanes, in particular, polyvinylsiloxanes, thermoplastic elastomers, thermoplastics. Several different coating materials can be used to produce the adhesive fastener part. Polysiloxanes, in particular, have proven to be advantageous for producing the adhesive fastener part. The coating material can also have a functionalization. For example, particles can be embedded in the coating material, e.g., in polysiloxane, for example color particles or the like.

In a further variant, the coating material is connected to the carrier web by coating, wherein the coating material is preferably structured during coating and/or after coating. As described above, the connection between the coating material and the carrier web can be realized in the form of a coating in order to form the adhesive elements on any surface. The coating can be applied flatly to the carrier web, for which purpose an extruder head or a corresponding nozzle can be used, for example. The thickness of the coating material that is connected to the carrier web by coating is typically in the order of magnitude between approximately 50 μm and 100 μm but can also be higher or lower. The thickness of the coating material can be specified or compensated for, for example, by using a doctor blade or the like.

It is possible for the coating material to be structured during coating and/or after coating. The structuring of the coating material can be achieved, for example, by coating using a printing process, e.g., screen printing, gravure printing, etc., to produce patterns, stripes, etc. For this purpose, a structured roller, a spray nozzle or a printer nozzle can be used, for example. It is also possible to structure the coating material after it has been applied in the form of a coating, e.g., by guiding it past a doctor blade or the like, which is structured and retains the coating material in predetermined areas, whereby, for example, a strip-shaped or island-shaped structure can be produced.

In a further variant, the mold screen of the molding tool is band-shaped and in order to form the adhesive elements in the mold cavities of the band-shaped mold screen, the carrier web is brought into contact with the band-shaped mold screen with the side facing the coating material, preferably guided along the band-shaped mold screen. In this variant, a band-shaped, usually metallic mold screen is used, which typically rotates around two rollers. The coating material is typically brought into contact with the band-shaped mold screen in the area of one of the two rollers, typically placed on the band-shaped mold screen, whereby the coating material penetrates into the mold cavities or flows into the mold cavities by capillary forces, usually without additional pressure having to be applied to the coating material or the carrier web for this purpose. However, it has proven to be advantageous to compensate for the waviness of the carrier web or to smooth it out with the help of a brush, broom or the like. The carrier web with the coating material is then guided along the band-shaped mold screen, or more precisely along a straight section of the band-shaped mold screen. After the adhesive elements have been formed by the penetration of the coating material into the mold cavities, the coating material can be cured, for example, by heat radiation or by UV light, while the carrier web is guided along the band-shaped mold screen.

It has been found that forming the adhesive elements using the band-shaped mold screen enables a particularly robust manufacturing process in which the parameter windows are significantly larger. In particular, the manufacturing process is less sensitive to material changes and to changes in the rheology of the coating material than forming the adhesive elements by pressing a pressure roller against a forming roller of a mold. Both the speed of forming the adhesive elements and the width of the adhesive fastener part can be significantly increased in this way, since even with a larger width, there is no tearing during demolding. In this variant, a rigid component can also be used as the carrier web, which is coated with the coating material and which is guided along the band-shaped mold screen to form the adhesive elements. When manufacturing using the band-shaped mold screen, the coating material is not pressed into the mold cavities but runs into them. In this way, the manufacturing process can be carried out with a device with significantly lower accuracy requirements.

According to a further aspect, the object is achieved by a device of the type mentioned at the outset, which has a further feed device for feeding a carrier web to the coating material, wherein the device is designed to form the adhesive elements on a side of the carrier web facing the coating material in the mold cavities of the molding tool. The device is preferably designed to connect the carrier web to the coating material before forming the adhesive elements, in particular, before the carrier web and the coating material reach the molding tool. In this case, the coating material and the carrier web are already in contact with one another or are connected to one another before they reach the molding tool.

The further feed device can be designed as an unwinding device or have an unwinding device in order to unroll or unwind the carrier web from a roller or a roll. The feed device can also be designed to feed the carrier web to the shaping tool via a roller or via a defined gap. For example, the coating material and the carrier web can be fed to the shaping tool via a defined feed gap that runs between two rollers, with one of the two rollers forming a pressure roller that interacts with the shaping tool, e.g., in the form of a forming roller. The coating material can be pressed against the carrier web by the feed gap or by specifying a defined gap width of the feed gap, which promotes the connection of the coating material to the carrier web.

The shaping tool can be designed to form a coating web between the carrier web and the adhesive elements made of the coating material, which has a thickness of 2 mm or less, preferably 300 μm or less, particularly preferably 200 μm or less, very particularly preferably 50 μm or less, extremely preferably 30 μm or less, in particular, 10 μm or less. As described above, by using the carrier web to produce the adhesive fastener part, a coating web with a smaller thickness can be formed than would be the case without the carrier web.

In one embodiment, the molding tool has a forming roller that interacts with a pressure tool in the form of a pressure roller, wherein a conveying gap is formed between the pressure roller and the forming roller, and wherein the device is designed to guide the carrier web through the conveying gap. By specifying the height of the conveying gap between the pressure roller and the forming roller, the thickness of the coating web on which the adhesive elements are formed can be specified.

In a further development of this embodiment, the conveying gap has a height which exceeds the thickness of the carrier web by 2 mm or less, preferably by 300 μm or less, particularly preferably by 200 μm or less, very particularly preferably 50 μm or less, extraordinarily preferably by 30 μm or less, in particular, by 10 μm or less, or corresponds to the thickness of the carrier web. As described above, the thickness of the coating material on which the adhesive elements are formed can be specified by specifying the height of the conveyor gap. In the event that the height of the conveyor gap corresponds to the thickness of the carrier web, the adhesive elements are formed directly on the carrier web, i.e., no continuous coating web is formed during production of the adhesive fastener part which connects the adhesive elements to one another.

In an alternative embodiment, the mold screen of the molding tool is designed in a band-shaped manner and the device is designed to bring the carrier web into contact with the band-shaped mold screen with the side facing the coating material in order to form the adhesive elements in the mold cavities, preferably to guide the carrier web along the band-shaped, usually metallic mold screen. As described above in connection with the method, this allows the coating material to conform better and the capillary to be filled better than is the case when using a forming roller and a pressure roller to form the adhesive elements. Both the speed of forming the adhesive elements and the width of the adhesive fastener part produced can be significantly increased in this way.

The device can have a curing device for curing the coating material after the adhesive elements have been formed, the curing device preferably being designed for curing the coating material after the adhesive elements have been removed from the mold or before demolding. As described above in connection with the method, curing can be carried out, for example, by heat, by light and/or by air humidity. The curing device can have one or more heating elements, one or more heat radiators, light sources and/or a device for increasing the air humidity in the area surrounding the adhesive fastener part.

A further aspect of the invention relates to a fastener part of the type mentioned at the outset, which is produced, in particular, according to the method described above, in which the adhesive elements are formed on a one-piece coating web which is attached to a carrier web, or in which the adhesive elements are attached directly to the carrier web. As described above, the coating web of the fastener part which is attached to the carrier web or connected to the carrier web can have a smaller thickness than is the case with an fastener part without a carrier web. In the event that the adhesive elements are attached directly to the carrier web, the material of the adhesive elements typically differs from the material of the carrier web.

The coating web can have a thickness of 2 mm or less, preferably 300 μm or less, particularly preferably 200 μm or less, very particularly preferably 50 μm or less, extremely preferably 30 μm or less, in particular, 10 μm or less. In particular, the thickness of the coating web can be 0 μm. In the latter case, the adhesive elements are attached directly to the carrier web.

The carrier web can have a thickness of 10 mm or less, preferably 60 μm or less, particularly preferably 40 μm or less. In this way, the material requirement in the production of the adhesive fastener part can be further reduced.

The adhesive elements can have a height of at least 20 μm, at least 30 μm, or at least 40 μm. A minimum height of the adhesive elements is typically required to enable adhesion or attachment to smooth surfaces of other components. The adhesive elements generally have a height that is not greater than 800 μm, in particular, not greater than 150 μm. The aspect ratio of the adhesive elements, i.e., the ratio of the height to the width of the adhesive elements, is preferably between 0.1 and 3.0.

As described above in connection with the method, the carrier web is designed as a flexible component, preferably as a film, in particular, as an information-carrying film, or as a rigid component. The carrier web in the form of the film can be made, for example, from polyurethane (PUR), from polyethylene terephthalate (PET) or from acrylate foam. The carrier web in the form of the film can also be made from other materials.

As described above, the material of the carrier web can, for example, be selected from the group comprising: textile, nonwoven, foam, in particular, acrylate foam, polyurethane, thermoplastics.

It is possible that a connecting agent, in particular, an adhesive layer, is applied to a side of the carrier web facing away from the coating material. The connecting agent, for example in the form of the adhesive layer, can serve to permanently connect the adhesive fastener part to another component. The adhesive layer can be applied to the side of the carrier web facing away from the coating material after demolding from a mold, but it is also possible that the adhesive layer is already applied or will be applied to the side of the carrier web facing away from the coating material when the carrier web is fed to the mold. It is also possible, in particular, that the carrier web itself consists of an adhesive or contains an adhesive. In this case, a finished adhesive fastener part can be formed in one step.

In a further embodiment, the adhesive elements on the carrier web, more precisely on the carrier surface of the carrier web, have a surface density of at least 10,000/cm² and not more than 100,000/cm², preferably of at least 25,000/cm² and not more than 50,000/cm². For reliable, releasable adhesion of the adhesive fastener part to a smooth surface of one or more other components by means of adhesive force, a high surface density of the adhesive elements is required.

The surface density, i.e., the number of adhesive elements per cm² of the carrier surface, which is required for a reliable, removable attachment by means of adhesive force, is significantly greater than with hooking means which are intended to work together with other hooking means, for example, with fleece or hook material, in order to achieve a removable attachment.

The adhesive elements are typically mushroom-shaped and have a head area on which a contact surface is formed on the front side. The head area is typically followed by a stem that merges into a foot section. The adhesive elements can be rotationally symmetrical, but this is not absolutely necessary. The head area of the mushroom-shaped adhesive elements protrudes laterally over the stem. The foot section also usually protrudes laterally over the stem. The adhesive elements are typically solid, i.e., they do not have a cavity.

In a further embodiment, a plurality of further adhesive elements made of a coating material with front-side contact surfaces for releasable adhesion to further components by means of adhesive force are attached to a side of the carrier web opposite the adhesive elements, wherein the further adhesive elements are preferably either formed on a further one-piece coating web that is attached to the carrier web or are attached directly to the carrier web. As described above in connection with the method, the further adhesive elements can be formed on the side of the carrier web opposite the adhesive elements by the carrier web passing through the device for producing the adhesive fastener part twice with the sides of the carrier web in reverse orientation. In this case, the carrier web can be formed in one piece, but this is not absolutely necessary.

However, it is also possible to produce the adhesive fastener part described here, which has adhesive elements on both sides of the carrier web, in a different way. For example, the carrier web of the adhesive fastener part described here can have two layers that are arranged one above the other, with the adhesive elements being formed on one layer and the other adhesive elements on the other layer. The two layers with the associated adhesive elements can initially be produced separately—e.g., in the manner described above—and then brought together and connected to one another. The connection between the two layers can be made, for example, by an adhesive layer.

At least some of the adhesive elements can advantageously be designed the same or similar to the other adhesive elements. In particular, the adhesive elements and the other adhesive elements can be designed the same. In this way, the manufacture of the double-sided adhesive fastener part can be simplified.

The adhesive elements and the other adhesive elements can have the same surface density. However, it has proven to be advantageous if the adhesive elements and the other adhesive elements have a different surface density. In particular, the adhesive elements on the carrier surface of the carrier web can be arranged with a surface density of 25,000 adhesive elements/cm ² to 50,000 adhesive elements/cm ² and the other adhesive elements on the opposite carrier surface of the carrier web can be arranged with a surface density of 15,000 adhesive elements/cm² to 20,000 adhesive elements/cm².

Further advantages of the invention emerge from the description and the drawing. Likewise, the features mentioned above and those described below can be used individually or in combination in any desired way. The embodiments shown and described are not to be understood as an exhaustive list, but rather are exemplary in nature for describing the invention.

### BRIEF DESCRIPTION OF THE DRAWINGS

FIG. 1a shows schematically shows a partially sectioned view of a device for producing a fastener part according to the prior art;

FIG. 1b shows schematically a detail of an adhesive fastener part produced by means of the device of FIG. 1a;

FIG. 2a shows a schematic, partially sectioned view of a device according to the invention for producing an adhesive fastener part according to the invention;

FIG. 2b shows schematically a detail of an adhesive fastener part produced by means of the device of FIG. 2a or of FIG. 4;

FIG. 2c shows schematically a detail of another fastener part produced by means of the device of FIG. 2a or of FIG. 4;

FIG. 3 shows schematically a detail of another fastener part produced by means of the device of FIG. 2a or of FIG. 4; and

FIG. 4 shows a schematic, partially sectioned view of another device according to the invention for producing an adhesive fastener part according to the invention.

### DETAILED DESCRIPTION OF EMBODIMENTS OF THE INVENTION

In the following description of the drawings, identical reference symbols are used for identical or functionally identical components.

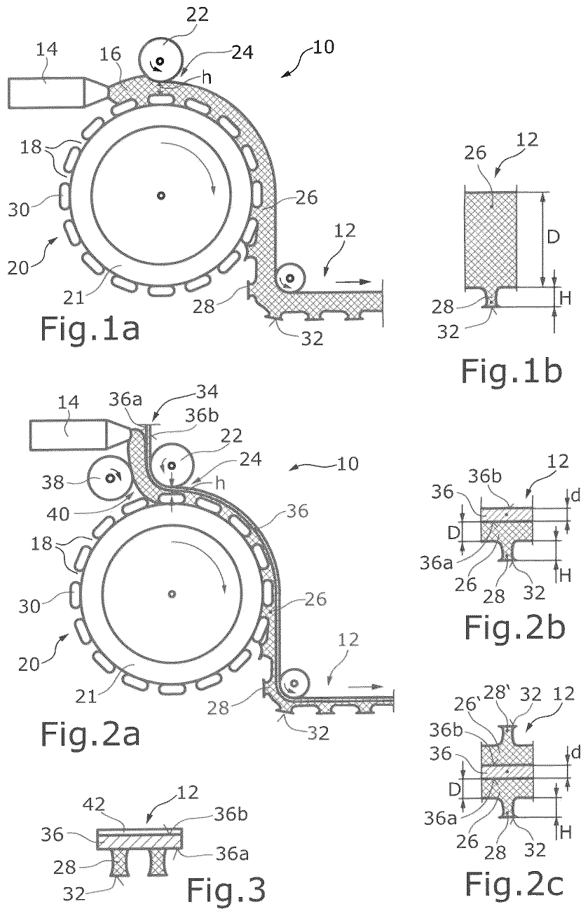

FIG. 1a shows a schematic of a device 10 for producing an adhesive fastener part 12, with which a method for producing the adhesive fastener part 12 is carried out. The device 10 has a feed device 14 in the form of an extruder head, which serves to feed a coating material 16 in a liquid or plastic state to mold cavities 18 of a molding tool 20. The molding tool 20 has a forming roller 21, which cooperates with a pressure tool in the form of a pressure roller 22 to produce the adhesive fastener part 12.

The pressure roller 22 and the forming roller 21 are each driven in directions of rotation indicated by curved arrows. A conveying gap 24 is formed between the pressure roller 22 and the forming roller 21, through which the strip-shaped coating material 16 is conveyed in a transport direction which is indicated in FIG. 1a by a horizontal arrow. The conveying gap 24 also serves as a shaping zone and shapes the coating material 16 into a coating web 26, wherein at the same time the side of the coating material 16 facing the forming roller is pressed into the mold cavities 18 and adhesive elements 28 are formed from the coating material 16 in the mold cavities 18. The mold cavities 18 are attached to a shaping layer in the form of a metallic mold screen 30 or are formed in this. The mold cavities 18 are arranged in a regular distribution on the outer circumference of the forming roller 21, whereby the number and distribution of the mold cavities 18 of the metallic mold screen 30 can in principle be freely selected.

After the adhesive elements 28 have been removed from the molding tool 20, the band-shaped adhesive fastener part 12 is formed, of which a small section with an adhesive element 28 is shown in FIG. 1b. The adhesive element 28 has a front contact surface 32 which is used for releasable adhesion to other components by means of adhesive force. The contact surface 32 is very small and in the example shown has an area of approximately 2000 μm². The height H of each adhesive element 28 is approximately 50 μm in the example shown but can also be smaller or larger. The height H can, for example, be in a value range between approximately 20 μm and approximately 100 μm. In the example shown, the adhesive elements 28 are mushroom-shaped and have a head region on which the contact surface 32 is formed on the front. The head region is followed by a stem which merges into a foot part. The head region of the adhesive elements 28 projects laterally beyond the stem of the adhesive elements 28.

As can be seen in FIG. 1b, the coating web 26, which is formed in the forming zone in the conveying gap 24 between the pressure roller 22 and the forming roller 21, has a relatively large thickness D in the order of approximately 300 μm in order to avoid tearing of the coating web 26 during the production of the adhesive fastener part 12 in the device 10. The adhesive fastener part 12 produced in this way is quite stiff due to the large thickness D of the coating web 26 and its production is material-intensive.

FIG. 2a shows a device 10 for producing a band-shaped adhesive fastener part 12, which differs from the device 10 shown in FIG. 1a in that it has a further feed device 34, which is designed to feed a carrier web 36 to the molding tool 20. The further feed device 34 is designed in FIG. 2a in the form of an unwinding device (not shown in the picture), from which the carrier web 36 is unwound. The carrier web 36 is fed to the molding tool 20, which has the forming roller 21, together with the band-shaped coating material 16, wherein a first side 36a of the carrier web 36 facing the coating material 16 rests against the coating material 16 and connects with the coating material 16 before the adhesive elements 28 are formed in the mold cavities 18.

The device 10 or the further feed device 34 is designed to guide the carrier web 36 together with the coating material 16 through the conveying gap 24. The carrier web 36 is guided on a side of the coating material 16 facing away from the forming roller 21. For the joint guidance of the strip-shaped coating material 16 and the carrier web 36, the device 10 has a further pressure roller 38 which cooperates with the pressure roller 22 to guide the carrier web 36 and the coating material 16 together through a feed gap 40 between the pressure roller 22 and the further pressure roller 38. The coating material 16 is pressed against the carrier web 36 by the feed gap 40, which promotes the formation of a permanent connection between the carrier web 36 and the coating material 16. It is understood that the feeding of the carrier web 36 to the molding tool 20 is also possible in a manner other than that described here, e.g., in the manner described further below.

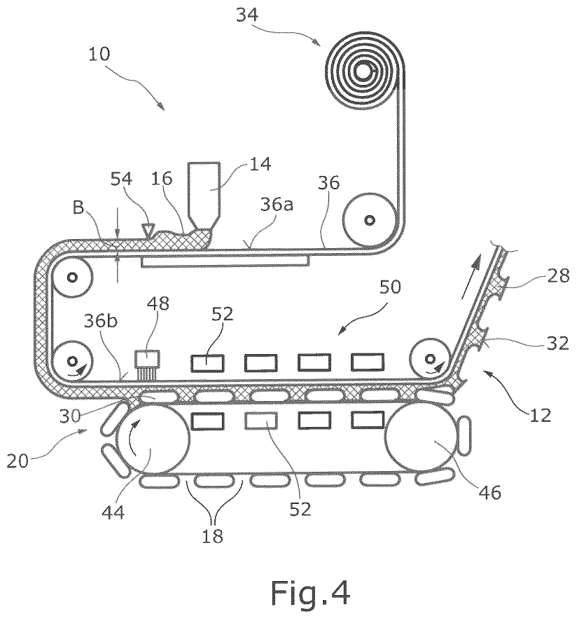

By attaching the coating web 26 to the carrier web 36 or by connecting the coating web 26 to the carrier web 36, the coating web 26 of the adhesive fastener part 12 can be made significantly thinner, as can be seen by comparing FIG. 2b, which shows the adhesive fastener part 12 produced with the device 10 of FIG. 2a or with the device 10 described further below in connection with FIG. 4, with the adhesive fastener part 12 shown in FIG. 1b: The thickness D of the coating web 26 in the adhesive fastener part 12 shown in FIG. 2b is approximately 50 μm or less, e.g., 30 μm or less or approximately 10 μm or less, but can also be larger and be 2 mm or less, 300 μm or less, 200 μm or less or 100 μm or less. The thickness d of the carrier web 36 is also comparatively small and is approximately 60 μm or less, e.g., 40 μm or less. The thickness d of the carrier web 36 should not be less than a minimum thickness, which depends on the material of the carrier web 36 and is generally in the order of magnitude of approximately 25 μm.

FIG. 2c shows an adhesive fastener part 12 which has a further coating web 26′ with further adhesive elements 28′ on a second side 36b of the carrier web 36. The further coating web 26′ and the further adhesive elements 28′ are formed in the same way as the coating web 26 and the adhesive elements 26 on the first side 36a of the carrier web 36. The adhesive fastener part shown in FIG. 2c is obtained by the carrier web 36 passing through the device 10 shown in FIG. 2a or in FIG. 4 twice, the two sides 36a, 36b of the carrier web 36 being aligned in opposite directions during the two passes through the device 10. The double-sided adhesive fastener part 12 shown in FIG. 2c can also have a carrier web 26 with two layers lying one above the other, which have the adhesive elements 28 and the further adhesive elements 28′ respectively. The two layers of such a carrier web 26 can be connected to each other, for example, by an adhesive layer.

In both the device 10 shown in FIG. 1a and in FIG. 2a, the coating material 16 is typically cured after the adhesive elements 28 have been formed by heat, which is generated for example by the shaping tool 20, by light, for example by UV light, and/or by atmospheric humidity. During curing, the molecules or molecular chains of the coating material 16 are cross-linked. In the example shown, the coating material 16 is polysiloxane, but it can also be another elastomer, for example polyurethane. The coating material 16 can be suitably prepared for curing, for example it can be 2-component silicone rubber. In this case, a liquid silicone component can be mixed with a catalyst, e.g., a platinum catalyst, before extrusion in order to produce a coating material 16 in the form of a rubber-like mass, which vulcanizes or hardens after the adhesive elements 28 have been formed. Thermoplastic elastomers or thermoplastics can also be used as the coating material 16.

In the example shown, the carrier web 36 is designed as a film, i.e., the carrier web 36 forms a carrier film. The carrier film can carry information, but this is not absolutely necessary. Instead of a continuous film, the carrier web 36 can also be designed as a rigid component. The material of the carrier web 36 can be a textile, a fleece, a net, a foam, for example acrylate foam, polyurethane, elastomers, thermoplastic elastomers, thermosets or adhesives. It is also possible for the carrier web 36 to be made from a thermoplastic material, e.g., polyethylene terephthalate (PET). In this case, the carrier web 36 can be thermoformed, e.g., by a deep-drawing process, which enables the adhesive elements 28 to extend in different directions and to adhere in different directions.

To improve the (permanent) connection of the carrier web 36 to the coating material 16, the carrier web 36 can be provided with an adhesion promoter, e.g., with an adhesion promoter layer, on its first side 36a facing the coating material 16, or the first side 36a of the carrier web 36 can be subjected to a surface treatment. It is also possible in principle to connect the carrier web 36 to the coating material 16 in a detachable manner, in particular, in a peelable manner, so that the carrier web 36 can be separated or peeled off from the carrier web 36 after the adhesive elements 28 have been removed from the mold cavities 18 of the molding tool 20. In this case, the carrier web 36 serves only to prevent tearing of the coating material 16 during the production of the adhesive fastener part 12, so that the coating web 26 can be produced with a smaller thickness D than is described in connection with FIGS. 1 a,b.

The thickness D of the coating web 26 is essentially determined by the height h of the conveying gap 24 between the pressure roller 22 and the forming roller 20. In order to form the coating web 26 with the thickness D specified above, the height h of the conveying gap 24 should exceed the thickness d of the carrier web 36 by 2 mm or less, by 300 μm or less, by 200 μm or less, by 100 μm or less, by 50 μm or less, by 30 μm or less, or by 10 μm or less.

It is also possible for the height h of the conveying gap 24 to correspond substantially to the thickness d of the carrier web 36. In this case, the holding elements 28 are formed directly and individually on the carrier web 36, as shown in FIG. 3. On a second side 36b facing away from the coating material 16 of the adhesive elements 28, a connecting means, for example in the form of an adhesive layer 42, can be applied to the carrier web 36, as is also shown in FIG. 3. The adhesive layer 42 enables a permanent connection of the adhesive closure part 12 to another component, which is not shown in FIG. 3.

At the contact surfaces 32, the adhesive elements 28 of the fastener parts 12 shown in FIG. 2b and FIG. 3 adhere to another component (also not shown) that has a smooth surface, in a releasable manner by means of adhesive force. In order to enable reliable releasable adhesion of the adhesive fastener part 12 to the smooth surface of another component, the adhesive elements 28 of FIG. 2b and FIG. 3 have a surface density of at least 10000/cm² and of not more than 100,000/cm², typically of at least 25,000/cm² and of not more than 50,000/cm², on the carrier web 36. The adhesive elements 28 of the adhesive closure part 12 of FIG. 2c have a surface density of at least 25,000/cm² and of not more than 50,000/cm², the further adhesive elements 28′ of the adhesive closure part 12 of FIG. 2c have a surface density of at least 15,000/cm² and of not more than 20,000/cm².

It is understood that the manufacture of the adhesive fastener part 12 can also be carried out in a manner other than that described above. For example, instead of a molding tool 20 having a forming roller 21, a molding tool having two or more forming rollers can be used.

FIG. 4 shows a device 10 for producing the adhesive fastener part 12, which differs from the device 10 shown in FIG. 2a, among other things, in that the metallic mold screen 30 is band-shaped and rotates around a first roller 44 and a second roller 46. The distance between the two rollers 44, 46 is selected such that the mold screen 30 is tensioned, so that a straight section of the mold screen 30 is formed between the two rollers 44, 46, which section faces the coating material 16. The carrier web 36 is brought into contact with the band-shaped mold screen 30 with its side 36a facing the coating material 16 in the area of the first roller 44, or more precisely, is placed on the band-shaped mold screen 30. The coating material 16 flows through capillary forces into the mold cavities 18 of the band-shaped mold screen 30, whereby the adhesive elements 28 are formed in the mold cavities 18. The carrier web 36 is fed to the mold screen 30 parallel to the straight section that forms the top of the molding tool 20. A brush 48 presses on the side 36b of the carrier web 36 facing away from the coating material 16 in order to smooth it or to compensate for its waviness.

The carrier web 36 and thus the coating material 16 is guided along the straight section of the band-shaped mold screen 30 and the coating material 16 is demolded from the mold screen 30 in the area of the second roller 46, whereby the band-shaped adhesive fastener part 12 is formed. After the adhesive elements 28 have been formed by the penetration of the coating material into the mold cavities 18 of the mold screen 30, the coating material 16 is cured as it is guided along the carrier web 36 by a curing device 50 which has a plurality of heat radiators 52 which are arranged in the area of the straight section of the mold screen 30 on both sides 36a, 36b of the carrier web 36. The heat radiators 52 introduce IR radiation into the coating material 16 in order to cure it.

In the device 10 shown in FIG. 4, as in FIG. 2a, the coating material 16 is fed to the molding tool 20 by means of a feed device in the form of an extruder head 14. The carrier web 36 is coated with the coating material 16, wherein a coating height B is determined by a doctor blade 54, which serves to smooth the coating material 16. Typically, the coating height B of the coating material 16 is in the order of magnitude between approximately 50 μm and 150 μm. It is possible for the coating material 16 to be structured during coating or for the coating material 16 to be structured after coating, before the coating material 16 is fed to the molding tool 20.

### List of Reference Symbols

10 device
12 adhesive fastener part
14 feed device
16 coating material
18 mold cavity
20 molding tool
21 forming roller
22 pressure roller
24 conveying gap
26 coating web
26′ further coating web
28 adhesive element
28′ further adhesive element
30 mold screen
32 contact surface
34 further feed device
36 carrier web
36a first side of the carrier web
36b second side of the carrier web
38 further pressure roller
40 feed gap
42 adhesive layer
44 first roller
46 second roller
48 brush
50 curing device
52 heat radiators
54 doctor blade

What is claimed is:

1. A method for producing a fastener part, the method comprising the steps of:
providing a plurality of adhesive elements with frontal contact surfaces configured for releasable adhesion to further components by an adhesive force;
wherein each adhesive element of the plurality of the adhesive elements are formed in mold cavities of a mold screen of a molding tool from a coating material;
feeding a carrier web to the coating material wherein the adhesive elements are formed on a side of the carrier web facing the coating material in the mold cavities of the molding tool;
connecting the carrier web to the coating material before the adhesive elements are formed.

2. The method according to claim 1, wherein during the formation of the adhesive elements between the carrier web and the adhesive elements from the coating material a coating web is formed which has a thickness of 2 mm or less.

3. The method according to claim 2, wherein after the adhesive elements have been removed from the mold cavities of the molding tool, the carrier web is separated from the coating web.

4. The method according to claim 1, wherein the adhesive elements are formed directly on the side of the carrier web facing the coating material.

5. The method according to claim 1, wherein the coating material is cured after the formation of the adhesive elements by heat, by light, UV light and/or by atmospheric humidity.

6. The method according to claim 1, wherein the carrier web has a thickness of 10 mm or less.

7. The method according to claim 1, wherein the carrier web is designed as a flexible component being an information-carrying film or as a rigid component.

8. The method according to claim 1, wherein the carrier web is selected from the group comprising: textile, nonwoven, net, foam and acrylate foam.

9. The method according to claim 1, wherein a carrier web is fed to the coating material, which has, on a side facing away from the coating material, a plurality of further adhesive elements made of a coating material with front-side contact surfaces for releasable adhesion to further components by means of adhesive force.

10. The method according to claim 1, wherein the material of the carrier web is selected from the group comprising: polyurethane, elastomers, thermoplastic elastomers, thermoplastics, thermosets and adhesives.

11. The method according to claim 1, wherein the coating material is selected from the group comprising: elastomers, polyurethanes, polysiloxanes, polyvinylsiloxanes, thermoplastic elastomers and thermoplastics.

12. The method according to claim 1, wherein the coating material is connected to the carrier web by coating, wherein the coating material is structured during coating and/or after coating.

13. The method according to claim 1, wherein the mold screen of the molding tool is band-shaped, and wherein, in order to form the adhesive elements, the carrier web is brought into contact with the band-shaped mold screen with the side facing the coating material, guided along the band-shaped mold screen.

14. A device for producing an adhesive fastener part for carrying out the method according to claim 1, comprising:
the molding tool with the mold screen in which the mold cavities are formed;
a feed device for feeding the coating material to the mold cavities of the molding tool, which are designed to form the plurality of adhesive elements with front-side contact surfaces for releasable adhesion to further components by the adhesive force;
a further feed device for feeding the carrier web to the coating material, wherein the device is designed to form the adhesive elements on the side of the carrier web facing the coating material in the mold cavities of the molding tool, and wherein the device is designed to connect the carrier web to the coating material before forming the adhesive elements.

15. The device according to claim 14, wherein the molding tool has a forming roller which cooperates with a pressure tool in the form of a pressure roller, wherein a conveying gap is formed between the pressure roller and the forming roller, and wherein the device is designed to guide the carrier web through the conveying gap.

16. The device according to claim 15, wherein the conveying gap has a height which exceeds the thickness of the carrier web by 2 mm or less or which corresponds to the thickness of the carrier web.

17. The device according to claim 14, wherein the mold screen of the molding tool is band-shaped and the device is designed to bring the carrier web with the side facing the coating material into contact with the band-shaped mold screen in order to form the adhesive elements in the mold cavities.

18. The adhesive fastener part produced according to the method according to claim 1, comprising the plurality of adhesive elements made of the coating material with front-side contact surfaces for releasable adhesion to further components by the adhesive force, wherein the adhesive elements are formed on a one-piece coating web which is attached to the carrier web, or that the adhesive elements are attached directly to the carrier web.

19. The adhesive fastener part according to claim 18, wherein the carrier web is designed as a flexible component as an information-carrying film or as a rigid component.

20. The adhesive fastener part according to claim 18, wherein the adhesive elements on the carrier web have a surface density of at least 10,000/cm² and not more than 100,000/cm².

21. The adhesive fastener part according to claim 18, wherein a plurality of further adhesive elements made of a coating material with front-side contact surfaces for releasable adhesion to further components by means of adhesive force are attached to a side of the carrier web opposite the adhesive elements, wherein the further adhesive elements are either formed on a further one-piece coating web attached to the carrier web or are attached directly to the carrier web.
